(19) United States
(12) Patent Application Publication
(10) Pub. No.: US 2004/0191509 A1
(43) Pub. Date: Sep. 30, 2004

(54) Double-sided pressure-sensitive adhesive sheet and touch panel-provided display device

(75) Inventors: Hiroaki Kishioka, Ibaraki-shi (JP); Hiroyuki Tsubaki, Ibaraki-shi (JP)

Correspondence Address: SUGHRUE MION, PLLC, 2100 PENNSYLVANIA AVENUE, N.W., SUITE 800, WASHINGTON, DC, 20037, US

(73) Assignee: NITTO DENKO CORPORATION

(21) Appl. No.: 10/765,359

(22) Filed: Jan. 28, 2004

(30) Foreign Application Priority Data
Jan. 29, 2003 (JP) P. 2003-019992

(51) Int. Cl. B32B 7/12

(52) U.S. Cl. 428/354; 428/355 AC

(57) ABSTRACT

A double-sided pressure-sensitive adhesive sheet to be used in sticking and fixing a touch panel to a display surface of a display device is described, one surface of the double-sided pressure-sensitive adhesive sheet being stuck substantially entirely on the touch panel, and the other surface being stuck substantially entirely on the display surface of the display device, wherein the double-sided pressure-sensitive adhesive sheet has at least two adhesive layers but does not have a substrate, is constructed such that it is repeatedly peelable against at least one surface of the touch panel and the display surface of the display device, and has optical isotropy.

### FIELD OF THE INVENTION

The present invention relates to a double-sided pressure-sensitive adhesive sheet that is used in sticking and fixing a touch panel to a display surface of a display device and to a touch panel-provided display device.

### BACKGROUND OF THE INVENTION

In recent years, mobile communication terminals (such as mobile type telephone terminals such cellular telephones and PHS and PDA terminals) constitute a large market, and their growth in the future is expected. With respect to mobile communication terminals, examples of the main direction of technical destination include thin size, lightweight, low power consumption, high definition, and high luminance. In particular, in PDA mounted with a touch panel of the resistive film system as an input unit, there is generally employed a construction in which a touch panel of the resistive film system is mounted on an LCD module. In this touch panel of the resistive film system, an air layer is present between an upper electrode and a lower electrode, and a lowering of transmittance due to reflection regarding this air layer is obstacle to high luminance, low power consumption, etc. As methods for solving these problems, there is proposed an “inner touch panel system” in which a polarizing plate and a phase contrast plate in the upper portion of the LCD module are aligned in the upper portion of the touch panel. One example of the construction of such an inner touch panel system is shown in FIG. 3. In FIG. 3, 3 is a conductive film; 4 is a phase contrast plate; 5 is a polarizing plate; 6 is an LCD module; 7 is a polarizing plate; and 9 is the conventional double-sided pressure-sensitive adhesive tape. Incidentally, as the conventional double-sided pressure-sensitive adhesive tape 9 for touch panel sticking, a substrate-provided double-sided pressure-sensitive adhesive tape and a substrate-less double-sided pressure-sensitive adhesive tape composed of only one pressure-sensitive adhesive layer are enumerated [see JP-A-7-105781 (The term “JP-A” as used herein means an “unexamined published Japanese patent application”)]. The term “substrate-less” as used herein means “the absence of substrate”.

However, when the conventional substrate-less pressure-sensitive adhesive tape (substrate-less pressure-sensitive adhesive tape composed of only one pressure-sensitive adhesive layer) is used as a pressure-sensitive adhesive tape for sticking a touch panel, though it can be satisfied with optical isotropy, in the case where a mistake occurs during sticking, it may possibly be difficultly peeled away, or workability may be possibly reduced due to adhesive residue, leading to low “reworkability”. Incidentally, in the case of occurrence of adhesive residue, there may be the case of necessity of works for wiping up the residual adhesive, etc. Also, there may be the case where durability is low.

On the other hand, when a substrate-provided double-sided tape having such a form that different pressure-sensitive adhesives are coated on the both surfaces of a substrate such as biaxially stretched polyethylene terephthalate is used, though the reworkability and durability can be enhanced, it cannot be optically satisfied. Also, since the substrate is provided, there was involved a problem such that the thickness becomes thick in proportion thereto.

For those reasons, a double-sided pressure-sensitive adhesive sheet that can be satisfied with reworkability and optical properties at high levels and has a thin thickness is demanded. Further, a double-sided pressure-sensitive adhesive sheet further having excellent durability is demanded.

### SUMMARY OF THE INVENTION

Accordingly, an object of the invention is to provide a double-sided pressure-sensitive adhesive sheet having excellent reworkability and optical properties and having a thin thickness as a double-sided pressure-sensitive adhesive sheet to be used in sticking and fixing a touch panel to a display surface of a display device, and a touch panel-provided display device.

Another object of the invention is to provide a double-sided pressure-sensitive adhesive sheet further having excellent durability and a touch panel-provided display device.

For the sake of attaining the foregoing objects, the present inventors made extensive and intensive investigations. As a result, the present inventors made devices such that a double-sided pressure-sensitive adhesive sheet to be used in sticking and fixing a touch panel to a display surface of a display device is formed of only a pressure-sensitive adhesive layer without using a substrate. As a result, it has been found that when a double-sided pressure-sensitive adhesive sheet as prepared by forming a plurality of different pressure-sensitive adhesive layers is used, the optical properties can be satisfied; that after sticking and fixing a touch panel to a display surface of a display device via the double-sided pressure-sensitive adhesive sheet, when the touch panel is restuck to the display surface of the display device, resticking can be easily conducted, that is, reworkability is excellent; that by using an acrylic pressure-sensitive adhesive, durability can further be improved; and that thickness can be made thin because no substrate is present, leading to accomplishment of the invention.

Specifically, the invention is to provide a double-sided pressure-sensitive adhesive sheet to be used in sticking and fixing a touch panel to a display surface of a display device, one surface of the double-sided pressure-sensitive adhesive sheet being stuck substantially entirely on the touch panel, and the other surface being stuck substantially entirely on the display surface of the display device, wherein the double-sided pressure-sensitive adhesive sheet has at least two pressure-sensitive adhesive layers but does not have a substrate, is constructed such that it is repeatedly peelable against at least one surface of the touch panel and the display surface of the display device, and has optical isotropy.

The double-sided pressure-sensitive adhesive sheet may have from two to five pressure-sensitive adhesive layers. It is preferable that the pressure-sensitive adhesive layers at least in the both outer sides are formed of an acrylic pressure-sensitive adhesive. Also, it is suitable that at least one pressure-sensitive adhesive layer of the pressure-sensitive adhesive layers in the both outer sides has a 180°-peeling adhesive strength (to a glass plate or a triacetyl cellulose film at a peeling rate of 300 mm/min at 23° C.) of not more than 5.0 N/20 mm.

The double-sided pressure-sensitive adhesive sheet according to the invention can be used for fixing a display device to a touch panel in the inner touch panel system.

Also, the invention is to provide a touch panel-provided display device, wherein a display device and a touch panel are fixed to each other via the foregoing double-sided pressure-sensitive adhesive sheet.

### BRIEF DESCRIPTION OF THE DRAWINGS

FIGS. 1A and 1B each is a schematic cross-sectional view to partially show an example of the double-sided pressure-sensitive adhesive sheet according to the invention.

FIG. 2 is a schematic cross-sectional view to show one example of the construction when the double-sided pressure-sensitive adhesive sheet as shown in FIG. 1A is used.

FIG. 3 is a schematic cross-sectional view to show an example of the use embodiment of the conventional double-sided pressure-sensitive adhesive sheet.

Description of Reference Numerals and Signs

1: Double-sided pressure-sensitive adhesive sheet

2a: Pressure-sensitive adhesive layer in the touch panel side

2b: Pressure-sensitive adhesive layer in the display device side

11: Double-sided pressure-sensitive adhesive sheet

21a: Pressure-sensitive adhesive layer in the touch panel side

21b: Pressure-sensitive adhesive layer in the display device side

21c: Intermediate pressure-sensitive adhesive layer

3: Touch panel (conductive film)

3a: Conductive film in the upper side

3b: Conductive film in the lower side

3c: Adhesive layer

3d: Silver paste layer

4: Phase contrast plate

5: Polarizing plate

6: LCD module

7: Polarizing plate

8: Backlight

8a: Frame-shape double-sided pressure-sensitive adhesive tape

### DETAILED DESCRIPTION OF THE INVENTION

The invention will be hereunder described with reference to drawings. Incidentally, the identical members or sites may be designated with the same reference numerals or signs.

(Double-Sided Pressure-Sensitive Adhesive Sheet)

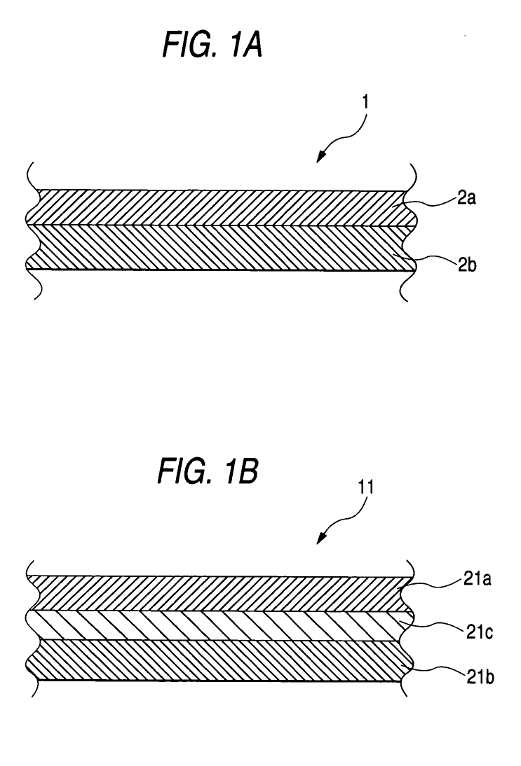

FIG. 1A or FIG. 1B is a schematic cross-sectional view to partially show an example of the double-sided pressure-sensitive adhesive sheet according to the invention. In FIGS. 1A and 1B, 1 is a double-sided pressure-sensitive adhesive sheet; 2a is a pressure-sensitive adhesive layer in the touch panel side; 2b is a pressure-sensitive adhesive layer in the display device side; 11 is a double-sided pressure-sensitive adhesive sheet; 21a is a pressure-sensitive adhesive layer in the touch panel side; 21b is a pressure-sensitive adhesive layer in the display device side; and 21c is an intermediate pressure-sensitive adhesive layer. The double-sided pressure-sensitive adhesive sheet 1 has a construction in which the pressure-sensitive adhesive layer 2a in the touch panel side and the pressure-sensitive adhesive layer 2b in the display device side are laminated (two-layer construction). Also, the double-sided pressure-sensitive adhesive sheet 11 has a construction in which the pressure-sensitive adhesive layer 21a in the touch panel side, the intermediate pressure-sensitive adhesive layer 21c, and the pressure-sensitive adhesive layer 21b in the display device side are laminated in that order (three-layer construction).

The double-sided pressure-sensitive adhesive sheet has at least two pressure-sensitive adhesive layers in this way. The layer construction of the pressure-sensitive adhesive layer is not particularly limited so far as it is of a layer construction of at least two layers. However, a layer construction of from 2 to 5 layers (preferably from 2 to 3 layers) is desirable. Incidentally, with respect to the pressure-sensitive adhesive layer, the layer construction of 2 layers is suitable from the viewpoint of making the thickness thin, and the layer construction of 3 layers is suitable from the viewpoint of improving the processability.

With respect to the pressure-sensitive adhesive layers in the both outer sides, one of them is a pressure-sensitive adhesive layer in the touch panel side, and the other is a pressure-sensitive adhesive layer in the display device side. Also, in the case where the pressure-sensitive adhesive layer is of a layer construction of three or more layers, the pressure-sensitive adhesive layer or layers other than those in the both outer sides are an intermediate pressure-sensitive adhesive layer.

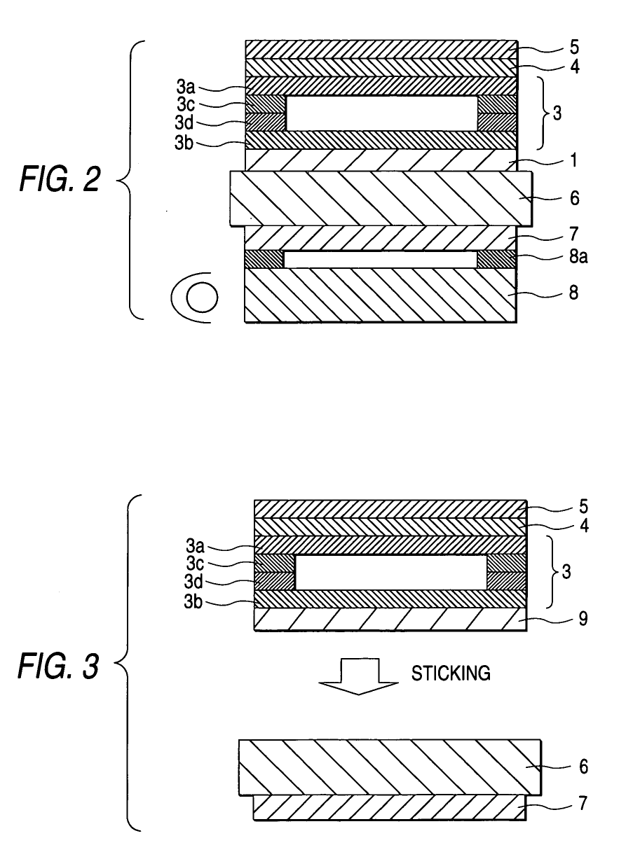

The double-sided pressure-sensitive adhesive sheet (1, 11) can be, for example, used in sticking a touch panel made of two transparent conductive plastic films [a transparent plastic film (conductive film) made of, for example, a polyethylene terephthalate film or a norbornene based resin film as a substrate, on one surface of which is formed a conductive layer of ITO (indium-tin oxide), etc.] to a display device as shown in FIG. 2. FIG. 2 is a schematic cross-sectional view to show one example of the construction when the double-sided pressure-sensitive adhesive sheet 1 as shown in FIG. 1A is used. In FIG. 2, 3 is a touch panel (conductive film); 3ais a conductive film in the upper side; 3b is a conductive film in the lower side; 3c is an adhesive layer; 3d is a silver paste layer; 4 is a phase contrast plate; 5 is a polarizing plate; 6 is an LCD module; 7 is a polarizing plate; 8 is a backlight; 8a is a frame-shape double-sided pressure-sensitive adhesive tape; and 1 is similarly a double-sided pressure-sensitive adhesive sheet.

In the use embodiment shown in FIG. 2, the LCD module 6 is used as a display device, and this embodiment is concerned with the use embodiment of a liquid crystal display. In FIG. 2, the touch panel 3 made of the two conductive films (3a, 3b) is stuck to the LCD module 6 via the double-sided pressure-sensitive adhesive sheet 1; the polarizing plate 7 to be used in the LCD module 6 is present on the other surface of the LCD module 6 (opposite surface to the touch panel 3); and the backlight 8 is stuck to the surface in the lower side of the polarizing plate 7 (opposite surface to the LCD module 6) via the frame-shape double-sided pressure-sensitive adhesive tape 8a. On the other hand, the phase contrast plate 4 and the polarizing plate 5 are provided in that order on the upper surface or the surface in the surface side of the touch panel 3 (opposite surface to the LCD module 6). That is, FIG. 2 shows one example of the use embodiment in which the double-sided pressure-sensitive adhesive sheet of the invention is applied to an inner touch panel system. More concretely, one surface of the double-sided pressure-sensitive adhesive sheet 1 is stuck substantially entirely on the touch panel 3, and the other surface is stuck substantially entirely on the display surface of the LCD module 6. Thus, the double-sided pressure-sensitive adhesive sheet 1 can be used in an embodiment in which it is stuck to the substantially entire surface of the touch panel and the substantially entire surface of the display surface of the display device, whereby no air interface is present between the touch panel and the display device.

Incidentally, in the double-sided pressure-sensitive adhesive sheet (1, 11), the pressure-sensitive adhesive layer in the touch panel side (2a, 21a) is a pressure-sensitive adhesive layer to be used in sticking to the touch panel. For example, in FIG. 2, the pressure-sensitive adhesive layer in the touch panel side can be stuck to the surface in the lower side of the touch panel 3 (outer surface of the conductive film 3b in the lower side). On the other hand, the pressure-sensitive adhesive layer in the display device side (2b, 21b) is a pressure-sensitive adhesive layer to be used in sticking to the display device. For example, in FIG. 2, the pressure-sensitive adhesive layer in the display device side can be stuck on the display surface of the LCD module 6 (outer surface in the upper side).

Though the method of imparting optical isotropy to the double-sided pressure-sensitive adhesive sheet is not particularly limited, a method of making all the pressure-sensitive adhesive layers in the double-sided pressure-sensitive adhesive sheet as a transparent pressure-sensitive adhesive layer having optical isotropy can be suitably employed. By enhancing transparency of all the pressure-sensitive adhesive layers and imparting optical isotropy to all the pressure-sensitive adhesive layers, the double-sided pressure-sensitive adhesive sheet can exhibit excellent optical properties.

In the invention, it is important that the double-sided pressure-sensitive adhesive sheet is constructed such that in sticking and fixing a touch panel to a display surface of a display device via the double-sided pressure-sensitive adhesive sheet, it is repeatedly peelable against at least one surface of the touch panel and the display surface of the display device. In particular, it is optimum that the double-sided pressure-sensitive adhesive sheet is constructed such that it is repeatedly peelable from the display surface of the display device together with the touch panel. The “construction in which the double-sided pressure-sensitive adhesive sheet is repeatedly peelable against at least one surface of the touch panel and the display surface of the display device” means a “construction in which after sticking the touch panel to the display surface of the display device via the double-sided pressure-sensitive adhesive sheet, the double-sided pressure-sensitive adhesive sheet can be peeled away from an interface between the pressure-sensitive adhesive layer (of the double-sided pressure-sensitive adhesive sheet, which is in contact with either one of the touch panel or the display surface of the display device) and either one of the touch panel or the display surface of the display device, and more suitably, the construction of the double-sided pressure-sensitive adhesive sheet and the touch panel or the display device, which has been once peeled away, can be again stuck to the touch panel or the display surface of the display device”. Accordingly, the “construction in which the double-sided pressure-sensitive adhesive sheet is repeatedly peelable from the display surface of the display device together with the touch panel” means a “construction in which after sticking the touch panel to the display surface of the display device via the double-sided pressure-sensitive adhesive sheet, the double-sided pressure-sensitive adhesive sheet can be peeled away from an interface between the display surface of the display device and the pressure-sensitive adhesive layer in the display device side of the double-sided pressure-sensitive adhesive sheet together with the touch panel, and more suitably, the construction of the double-sided pressure-sensitive adhesive sheet and the touch panel, which has been once peeled away, can be again stuck to the display surface of the display device”.

Incidentally, in such repeatedly peelable construction, for example, when the double-sided pressure-sensitive adhesive sheet is peeled away from the display surface of the display device together with the touch panel, the double-sided pressure-sensitive adhesive sheet can be peeled away without causing adhesive residue. Also, in the case of a construction in which the double-sided pressure-sensitive adhesive sheet can be again stuck, the double-sided pressure-sensitive adhesive sheet can be peeled away without causing anomalies such as generation of cracks in the transparent conductive member constructing the touch panel. Further, when the construction of the double-sided pressure-sensitive adhesive sheet and the touch panel, which has been once peeled away, is again stuck to the display surface of the display device, the double-sided pressure-sensitive adhesive sheet can be stuck without mingling of bubbles caused by rough pressure-sensitive adhesive coat of the surface of the pressure-sensitive adhesive layer in the display device side.

In the double-sided pressure-sensitive adhesive sheet (1, 11), as the repeatedly peelable construction, for example, a repeatedly peelable construction that is exhibited by the relationship of adhesive strength between the pressure-sensitive adhesive layer in the touch panel side (2a, 21a) and the pressure-sensitive adhesive layer in the displace device side (2b, 21b) can be employed. For example, a repeatedly peelable construction that is exhibited by making the adhesive strength of the pressure-sensitive adhesive layer in the displace device side (2b, 21b) to the displayer surface of the display device 6 smaller than that of the pressure-sensitive adhesive layer in the touch panel side (2a, 21a) to the sticking surface of the touch panel 3 may be employed. Concretely, there is enumerated a construction in which at least one pressure-sensitive adhesive layer (usually, the pressure-sensitive adhesive layer in the display device side) of the pressure-sensitive adhesive layers in the both outer sides has a 180°-peeling adhesive strength (to a glass plate or a triacetyl cellulose film at a peeling rate of 300 mm/min at 23° C.) of not more than 5.0 N/20 mm. More concretely, a construction in which the pressure-sensitive adhesive layer in the touch panel side (2a, 21a) has a 180°-peeling adhesive strength (to a norbornene based resin film at a peeling rate of 300 mm/min at 23° C.) of 5.5 N/20 mm or more, and the pressure-sensitive adhesive layer in the display device side (2b, 21b) has a 180°-peeling adhesive strength (to a glass plate or a triacetyl cellulose film at a peeling rate of 300 mm/min at 23° C.) of not more than 5.0 N/20 mm may be employed.

In this way, it is preferable that the 180°-peeling adhesive strength (to a norbornene based resin film at a peeling rate of 300 mm/min at 23° C.) of the pressure-sensitive adhesive layer in the touch panel side is larger than the 180°-peeling adhesive strength (to a glass plate or a triacetyl cellulose film at a peeling rate of 300 mm/min at 23° C.) of the pressure-sensitive adhesive layer in the display device side. The 180°-peeling adhesive strength (to a norbornene based resin film at a peeling rate of 300 mm/min at 23° C.) of the pressure-sensitive adhesive layer in the touch panel side is preferably 5.5 N/20 mm or more (for example, from 5.5 to 25 N/20 mm), and more preferably 6.0 N/20 mm or more (for example, from 6.0 to 20 N/20 mm). Incidentally, as the norbornene based resin film, for example, a trade name “ARTON” (manufactured by JSR Corporation) can be used.

Also, the 180°-peeling adhesive strength (to a glass plate or a triacetyl cellulose film at a peeling rate of 300 mm/min at 23° C.) of the pressure-sensitive adhesive layer in the display device side is, for example, from 0.1 to 5.0 N/20 mm, preferably from 0.5 to 3.0 N/20 mm, and more preferably from 1.0 to 2.5 N/20 mm. Incidentally, when the 180°-peeling adhesive strength (to a glass plate or a triacetyl cellulose film at a peeling rate of 300 mm/min at 23° C.) of the pressure-sensitive adhesive layer in the display device side exceeds 5.0 N/20 mm, when the double-sided pressure-sensitive adhesive sheet is peeled away from the display surface of the display device together with the touch panel, anomalies such as generation of cracks on the surface of a transparent conductive member constructing the touch panel and damages into the display device side are liable to occur.

When the double-sided pressure-sensitive adhesive sheet has the foregoing repeatedly peelable construction (in particular, when the pressure-sensitive adhesive layer in the display device side and the pressure-sensitive adhesive layer in the touch panel side each has the foregoing adhesive strength), after sticking and fixing the touch panel to the display surface of the display device via the double-sided pressure-sensitive adhesive sheet, in peeling the touch panel from the display surface of the display device and further resticking it to the display surface of the display device, the double-sided pressure-sensitive adhesive sheet can be easily peeled away from the display surface of the display device together with the touch panel without generation anomalies such as cracks on the surface of a transparent conductive member constructing the touch panel. Moreover, rough pressure-sensitive adhesive coat of the surface of the pressure-sensitive adhesive layer in the display device side is suppressed or prevented, and the construction of the double-sided pressure-sensitive adhesive sheet and the touch panel, which has been once peeled away, can be stuck to the display surface of the display device without mingling of bubbles into the interface between the pressure-sensitive adhesive layer in the display device side and the display surface of the display device. Accordingly, in the double-sided pressure-sensitive adhesive sheet having such a repeatedly peelable construction, after sticking and fixing the touch panel to the display surface of the display device via the double-sided pressure-sensitive adhesive sheet, the touch panel can be easily peeled away from the display surface of the display device. Also, the double-sided pressure-sensitive adhesive sheet has excellent reworkability such that the once peeled touch panel can be again stuck to the display surface of the display device.

The 180°-peeling adhesive strength (to a glass plate or a triacetyl cellulose film at a peeling rate of 300 mm/min at 23° C.) of the pressure-sensitive adhesive layer in the display device side can be, for example, measured in the following manner. That is, a polyethylene terephthalate film (for example, having a thickness of 25 μm) is stuck onto the pressure-sensitive adhesive layer in the touch panel side of the double-sided pressure-sensitive adhesive sheet, which is then cut into a width of 20 mm, and a glass plate or triacetyl cellulose film (for example, having a thickness of 1.0 μm) as an adherend is stuck onto the pressure-sensitive adhesive layer in the display device side. Thereafter, the construction is placed in an autoclave and treated for 15 minutes under the condition at 50° C. and 5 atmospheres. The resulting construction is taken out from the autoclave and allowed to stand for 120 minutes under the condition at 23° C. After standing, the 180°-peeling adhesive strength is measured when the double-sided pressure-sensitive adhesive sheet is peeled away from the adherend (in this case, the adherend is the glass plate or triacetyl cellulose film) at a stress rate of 300 mm/min using a tensile tester.

The 180°-peeling adhesive strength (to a norbornene based resin film at a peeling rate of 300 mm/min at 23° C.) of the pressure-sensitive adhesive layer in the touch panel side can be, for example, measured in the following manner. That is, a polyethylene terephthalate film (for example, having a thickness of 25 μm) is stuck onto the pressure-sensitive adhesive layer in the display device side of the double-sided pressure-sensitive adhesive sheet, which is then cut into a width of 20 mm, and a norbornene based resin film (for example, having a thickness of 70 μm) as an adherend is stuck onto the pressure-sensitive adhesive layer in the touch panel side. Thereafter, the construction is placed in an autoclave and treated for 15 minutes under the condition at 50° C. and 5 atmospheres. The resulting construction is taken out from the autoclave and allowed to stand for 120 minutes under the condition at 23° C. After standing, the 180°-peeling adhesive strength is measured when the double-sided pressure-sensitive adhesive sheet is peeled away from the adherend (in this case, the adherend is the norbornene based resin film) at a stress rate of 300 mm/min using a tensile tester.

The layer construction of the double-sided pressure-sensitive adhesive sheet of the invention is a layer construction having at least two pressure-sensitive adhesive layers, in which one of the pressure-sensitive adhesive layers in the both outer sides in the plural pressure-sensitive adhesive layers is the pressure-sensitive adhesive layer in the touch panel side, and the other is the pressure-sensitive adhesive layer in the display device side, as shown in FIGS. 1A and 1B. As the pressure-sensitive adhesive layer of forming the respective pressure-sensitive adhesive layers (such as the pressure-sensitive adhesive layer in the touch panel side, the pressure-sensitive adhesive layer in the display device side, and the intermediate pressure-sensitive adhesive layer), ones having transparency to such extent that visibility of the display device is not lowered are preferable, examples of which include known or usual pressure-sensitive adhesives such as acrylic pressure-sensitive adhesives, silicone based pressure-sensitive adhesives, polyester based pressure-sensitive adhesives, rubber based pressure-sensitive adhesives, and polyurethane based pressure-sensitive adhesives. The pressure-sensitive adhesive can be used singly or in admixture of two or more thereof. Also, the pressure-sensitive adhesive of forming the pressure-sensitive adhesive layer in the touch panel side, the pressure-sensitive adhesive of forming the pressure-sensitive adhesive layer in the display device side, and the pressure-sensitive adhesive of forming other pressure-sensitive adhesive layer (intermediate pressure-sensitive adhesive layer) may be the same kind of pressure-sensitive adhesive or different kinds of pressure-sensitive adhesives among them.

Incidentally, since the strength (adhesive strength) between the pressure-sensitive adhesive layers may possibly affect the reworkability, it is important to increase the strength between the pressure-sensitive adhesive layers. Though the method of increasing the strength between the pressure-sensitive adhesive layers is not particularly limited, a method of using a pressure-sensitive adhesive having a solubility parameter value (SP value) close to each other as the pressure-sensitive adhesives of forming the respective pressure-sensitive adhesive layers can be suitably employed. Concretely, in the case where an acrylic pressure-sensitive adhesive is used as the pressure-sensitive adhesive, for example, when a strong adhesion type acrylic pressure-sensitive adhesive containing butyl acrylate as the major monomer component is used as the pressure-sensitive adhesive of forming the pressure-sensitive adhesive layer in the touch panel side, it is preferable to use a weak adhesion type acrylic pressure-sensitive adhesive containing butyl acrylate as the major monomer component as the pressure-sensitive adhesive of forming the pressure-sensitive adhesive layer in the display device side. Also, it is preferable to use an acrylic pressure-sensitive adhesive containing butyl acrylate as the major monomer component as the pressure-sensitive adhesive of forming the intermediate pressure-sensitive adhesive layer.

As the pressure-sensitive adhesives of forming the respective pressure-sensitive adhesive layers, acrylic pressure-sensitive adhesives containing, as the major component or base polymer, an acrylic polymer containing a (meth)acrylic acid alkyl ester in which the alkyl moiety thereof has from 1 to 18 carbon atoms [(meth)acrylic acid C₁₋₁₈ alkyl ester] as the major monomer component are preferable from the standpoint of durability. When an acrylic pressure-sensitive adhesive is used as the pressure-sensitive adhesives of forming the pressure-sensitive adhesive layers at lest in the both outer sides in the double-sided pressure-sensitive adhesive sheet (preferably, all of the pressure-sensitive adhesive layers), it is possible to effectively enhance the durability and weather resistance of the double-sided pressure-sensitive adhesive sheet.

Examples of (meth)acrylic acid C₁₋₁₈ alkyl esters include methyl (meth)acrylate, ethyl (meth)acrylate, propyl (meth)acrylate, isopropyl (meth)acrylate, butyl (meth)acrylate, isobutyl (meth)acrylate, s-butyl (meth)acrylate, t-butyl (meth)acrylate, pentyl (meth)acrylate, hexyl (meth)acrylate, heptyl (meth)acrylate, octyl (meth)acrylate, isooctyl (meth)acrylate, 2-ethylhexyl (meth)acrylate, nonyl (meth)acrylate, isononyl (meth)acrylate, decyl (meth)acrylate, isodecyl (meth)acrylate, undecyl (meth)acrylate, and decyl (meth)acrylate. The (meth)acrylic acid C₁₋₁₈ alkyl ester can be used singly or in admixture of two or more thereof.

Also, in the acrylic polymer, a monomer component (copolymerizable monomer) that is copolymerizable with the (meth)acrylic acid C₁₋₁₈ alkyl ester may be used. In particular, in crosslinking the acrylic polymer, it is preferable to use a modifying monomer of acrylic pressure-sensitive adhesive as the copolymerizable monomer. As the modifying monomer, for example, any of various monomers that are known as the modifying monomer of acrylic pressure-sensitive adhesive can be used. The copolymerizable monomer can be used singly or in admixture of two or more thereof.

Specific examples of the copolymerizable monomers include copolymerizable monomers having various functional groups (especially polar groups) including vinyl esters such as vinyl acetate; cyano group-containing copolymerizable monomers such as (meth)acrylonitrile; amide group-containing copolymerizable monomers such as (meth)acrylamide and N,N-dimethyl (meth)acrylamide; hydroxyl group-containing copolymerizable monomers such as 2-hydroxyethyl (meth)acrylate, 3-hydroxypropyl (meth)acrylate, 4-hydroxybutyl (meth)acrylate, and 6-hydroxyhexyl (meth) acrylate; epoxy group-containing copolymerizable monomer such as glycidyl (meth)acrylate; amino group-containing copolymerizable monomers such as N,N-dimethylaminoethyl (meth)acrylic acid alkyl esters; and carboxyl group-containing monomers such as (meth)acrylic acid, crotonic acid, itaconic acid, maleic acid, maleic anhydride, and fumaric acid. Besides, examples of the copolymerizable monomers include styrene based monomers such as styrene; and α-olefin based monomers such as ethylene and propylene. The term “(meth)acrylic acid” as used herein refers to “acrylic acid and/or methacrylic acid”, the term “(meth)acrylate” as used herein refers to “acrylate and/or methacrylate”, the term “(meth)acrylamide” as used herein refers to “acrylamide and/or methacrylamide”, and the term “(meth)acrylonitrile” as used herein refers to “acrylonitrile and/or methacrylonitrile”.

As the modifying monomer, the foregoing functional group-containing copolymerizable monomers can be used. Of these, hydroxyl group-containing copolymerizable monomers and carboxyl group-containing copolymerizable monomers are preferable, and acrylic acid is especially preferable. Incidentally, it is possible to crosslink the acrylic polymer utilizing the functional group (especially the polar group) derived from the modifying monomer.

As the polymerization method for obtaining the acrylic polymer, a solution polymerization method using a polymerization initiator such as azo based compounds and peroxides, an emulsion polymerization method, a block polymerization method, and a polymerization method upon irradiation with light or radiations using a photoinitiator can be employed. In the invention, a method of conducting polymerization using a polymerization initiator capable of forming radicals upon decomposition (radical polymerization method) can be suitably employed. In the radical polymerization, polymerization initiators that are used in the usual radical polymerization can be used. Examples include peroxides such as dibenzoyl peroxide and tert-butyl permaleate; and azo based compounds such as 2,2′-azobisisobutyronitrile and azobisisovaleronitrile.

In the radical polymerization, the amount of the polymerization initiator to be used may be an amount that is usually employed in polymerizing the acrylic monomer and is, for example, from about 0.005 to 10 parts by weight, and preferably from about 0.1 to 5 parts by weight based on 100 parts by weight of the whole amount of the monomers.

It is important that the proportion of the (meth)acrylic acid C₁₋₁₈ alkyl ester as the major monomer component of the acrylic polymer is 50% by weight or more (preferably 80% by weight or more, and more preferably 90% by weight or more) based on the whole amount of the monomer components. Accordingly, the proportion of the copolymerizable monomer is not more than 50% by weight based on the whole amount of the monomer components.

In the invention, the acrylic polymer obtained by polymerization using the foregoing monomer components can be dried and then used as it is. Also, the acrylic polymer can be cured by crosslinking and then used. By crosslinking the polymer, it is possible to more increase a cohesive strength as the pressure-sensitive adhesive. In the case where the acrylic polymer is cured by the crosslinking, a crosslinking agent can be used. That is, in the acrylic pressure-sensitive adhesive, the crosslinking agent may be compounded together with the acrylic polymer. Incidentally, for crosslinking the polymer, a heat crosslinking method can be suitably used.

The crosslinking agent includes a wide variety of the conventionally known crosslinking agents. As the crosslinking agent, polyfunctional melamine compounds, polyfunctional epoxy compounds, and polyfunctional isocyanate compounds are especially preferable. The crosslinking agent can be used singly or in admixture of two or more thereof.

Examples of polyfunctional melamine compounds include methylated trimethylolmelamine and butylated hexamethylol-melamine. Also, examples of polyfunctional epoxy compounds include diglycidyl aniline and glycerin diglycidyl ether. The amount of the polyfunctional melamine compound and/or the polyfunctional epoxy compound to be used is, for example, in the range of from 0.001 to 10 parts by weight, and preferably from 0.01 to 5 parts by weight based on 100 parts by weight of the foregoing polymer.

Also, examples of polyfunctional isocyanate compounds include tolylene diisocyanate, hexamethylene diisocyanate, polymethylene polyphenylene isocyanate, diphenylmethane diisocyanate, a dimer of diphenylmethane diisocyanate, a reaction product of trimethylolpropane and tolylene diisocyanate, a reaction product of trimethyolopropane and hexamethylene diisocyanate, polyether polyisocyanate, and polyester polyisocyanate. The amount of the polyfunctional isocyanate compound to be used is, for example, in the range of from 0.01 to 20 parts by weight, and preferably from 0.05 to 15 parts by weight based on 100 parts by weight of the foregoing polymer.

Though the acrylic pressure-sensitive adhesive may be used as it is, it may be provided for use upon addition with various additives, if desired. For example, for the sake of adjusting the adhesive characteristics of the pressure-sensitive adhesive composition containing the foregoing acrylic polymer as the major pressure-sensitive adhesive component, known or usual tackifier resins (such as rosin based resins, terpene based resins, petroleum resins, coumaroneindene resins, and styrene based resins) may be compounded. However, it is preferable to use a hydrogenated tackifier in a compounding amount such that the haze value does not increase, from the viewpoints of enhancing the transparency and colorless properties of the double-sided pressure-sensitive adhesive sheet and suppressing the change in color tone. Also, as additives other than the tackifier resins, various known additives such as plasticizers, fillers such as finely divided silica, coloring agents, ultraviolet light absorbers, and surfactants can be compounded. The amounts of these additives may be the usual amounts that are applied to acrylic pressure-sensitive adhesives.

In the double-sided pressure-sensitive sheet, in the case where the pressure-sensitive adhesive layer in the touch panel side and the pressure-sensitive adhesive layer in the display device side are each formed of an acrylic pressure-sensitive adhesive, by employing a method such as a method of lowering the proportion of the modifying monomer (functional group-containing copolymerizable monomer) as far as possible, a method of making the crosslinking structure minute using a relatively large amount of the crosslinking agent, and a method of using a surfactant, it is possible to make the adhesive strength of the pressure-sensitive adhesive layer in the display device side to the display surface of the display device lower than the adhesive strength of the pressure-sensitive adhesive layer in the touch panel side to the sticking surface of the touch panel. In the invention, it is preferable that the adhesive strength of each of the pressure-sensitive adhesive layer in the display device side and the pressure-sensitive adhesive layer in the touch panel side is controlled by lowering the proportion of the functional group-containing copolymerizable monomer as far as possible. In that case, it is desirable that the proportion of the functional group-containing copolymerizable monomer is in the range of not more than 5% by weight (preferably not more than 3% by weight) based on the whole amount of the monomer components.

The double-sided pressure-sensitive adhesive sheet can be prepared by employing various methods including (1) a method in which the respective pressure-sensitive adhesive layers are individually prepared and then stuck to each other, (2) a method in which the respective pressure-sensitive adhesive layers are successively coated on a release film, (3) a method in which multiple pressure-sensitive adhesive layers are coated all at once to prepare a multilayered pressure-sensitive adhesive layer, and (4) a method in which on a single or multilayered pressure-sensitive adhesive layer, a different layer is formed utilizing interfacial contact reaction. Concretely, for example, the double-sided pressure-sensitive adhesive sheet can be prepared by coating a pressure-sensitive adhesive for forming the pressure-sensitive adhesive layer in the touch panel side on the release surface of a release film and drying to form the pressure-sensitive adhesive layer in the touch panel side; optionally coating a pressure-sensitive adhesive for forming the intermediate pressure-sensitive adhesive layer on the pressure-sensitive adhesive layer in the touch panel side and drying to form the intermediate pressure-sensitive adhesive layer of a single layer or two or more layers; further coating a pressure-sensitive adhesive for forming the pressure-sensitive adhesive layer in the display device side on the pressure-sensitive adhesive layer in the touch panel side or the intermediate pressure-sensitive adhesive layer and drying to form the pressure-sensitive adhesive layer in the display device side; optionally laminating a release film on the pressure-sensitive adhesive layer in the display device side; and further optionally conducting crosslinking and curing during or after the foregoing drying.

Incidentally, in the double-sided pressure-sensitive adhesive sheet, the pressure-sensitive adhesive layer in the touch panel side or the pressure-sensitive adhesive layer in the display device side may be protected by a release liner. In that case, for example, the foregoing release film can be used as a release liner. As the release liner, a release liner obtained by release treatment of the surface of a smooth plastic film (especially a PET film) can be suitably used. Incidentally, the release liner is peeled away to expose the pressure-sensitive adhesive layer in the touch panel side or the pressure-sensitive adhesive layer in the display device side, and then, the double-sided pressure-sensitive adhesive can be used.

The thickness of the pressure-sensitive adhesive layers (such as the pressure-sensitive adhesive layer in the touch panel side, the pressure-sensitive adhesive layer in the display device side, and the intermediate pressure-sensitive adhesive layer) is not particularly limited. For example, the thickness of each of the pressure-sensitive adhesive layer in the touch panel side and the pressure-sensitive adhesive layer in the display device side can be chosen from the range of from about 5 to 30 μm (preferably from 10 to 30 μm, and more preferably from 15 to 25 μm). The thickness of the intermediate pressure-sensitive adhesive layer can be chosen from the range of from about 3 to 30 μm (preferably from 5 to 20 μm, and more preferably from 8 to 15 μm). The thickness of the pressure-sensitive adhesive layer in the touch panel side, the pressure-sensitive adhesive layer in the display device side and the intermediate pressure-sensitive adhesive layer may be the same or different. Incidentally, for the sake of making the thickness of the double-sided pressure-sensitive adhesive sheet thin as far as possible, it is preferable that the thickness of the intermediate pressure-sensitive adhesive layer is thinner than the thickness of each of the pressure-sensitive adhesive layer in the touch panel side and the pressure-sensitive adhesive layer in the display device side.

Also, the total thickness of the pressure-sensitive adhesive layers (or the thickness of the double-sided pressure-sensitive adhesive sheet) can be, for example, chosen from the range of from about 10 to 50 μm (preferably from 20 to 50 μm, and more preferably from 25 to 45 μm).

Coating of the pressure-sensitive adhesive can be carried out using a usual coater such as a gravure roll coater, a reverse roll coater, a kiss roll coater, a dip roll coater, a bar coater, a knife coater, and a spray coater.

It is preferable that the double-sided pressure-sensitive adhesive sheet has high transparency. For this purpose, it is preferable to use a pressure-sensitive adhesive having transparency as the pressure-sensitive adhesive of the double-sided pressure-sensitive adhesive sheet. For example, it is desirable that the double-sided pressure-sensitive adhesive sheet has transparency such that the total luminous transmittance in the visible light wavelength region (according to JIS K7136) is 85% or more (preferably 87% or more, and more preferably 90% or more)

Also, the haze of the double-sided pressure-sensitive adhesive sheet can be, for example, chosen from the range of not more than 2.0% (preferably not more than 1.0%, and more preferably not more than 0.5%).

Incidentally, the double-sided pressure-sensitive adhesive sheet can be used as a double-sided adhesive tape by cutting in a proper width and wining up in a roll shape.

(Touch Panel)

In the sense of making the most of the characteristics of the invention, the touch panel is preferably used in the touch panel of the “inner touch panel system” as shown in FIG. 2. However, the construction or kind of the touch panel is not particularly limited, but the touch panel can be used in a so-called “F/F type” touch panel, a so-called “F/G type” touch panel, a so-called “F/F/P type” touch panel, etc. Incidentally, the sticking surface of the touch panel (the surface to which the double-sided pressure-sensitive adhesive sheet is stuck) is usually the surface of a film or sheet made of a resin such as polyolefin based resins such as cyclic olefin based resins (such as norbornene based resins), polycarbonate based resins, polyacrylate based resins, and polyether sulfone based resins.

(Display Device)

The display device is not particularly limited, but examples include cathode ray tubes, plasma displays, and EL displays in addition to the liquid crystal display (LCD module 6) as shown in FIG. 2. Incidentally, the display surface of the LCD module 6 is made of triacetyl cellulose (TAC) or glass as the material. Also, the display device is provided with a polarizing plate. Accordingly, the display surface of the display device (the surface to which the double-sided pressure-sensitive adhesive sheet is stuck) is usually the surface of a glass plate or a TAC film.

The double-sided pressure-sensitive adhesive sheet of the invention is suitably used in an embodiment such that when sticking and fixing the touch panel to the display device, the double-sided pressure-sensitive adhesive sheet is stuck substantially entirely on the touch panel and substantially entirely on the display surface of the display device, respectively. Accordingly, when the double-sided pressure-sensitive adhesive sheet of the invention is used, since not only an air interface is not present between the touch panel and the display device, but also a lowering of visibility due to reflection at the air interface between the conductive films hardly occurs, it has very good visibility. Moreover, since the double-sided pressure-sensitive adhesive sheet is constructed so as to have high transparency, a lowering of transmittance of light from the display device is suppressed or prevented, and no change in color tone occurs. For those reasons, even when the double-sided pressure-sensitive adhesive sheet of the invention is applied to a touch panel having a construction of the inner touch panel system, the light of images or pictures from the display device is clearly visible even through the touch panel having a construction of the inner touch panel system, and the visibility can be kept high over a long period of time.

Also, since the double-sided pressure-sensitive adhesive sheet has optical isotropy, it can exhibit excellent optical characteristics.

Further, the double-sided pressure-sensitive adhesive sheet of the invention has a construction such that it is repeatedly peelable from the display surface of the display device together with the touch panel. Accordingly, after sticking it to the touch panel and the display surface of the display device, when due to a mistake of sticking during sticking the touch panel to the display device or repair or recycling after long-term use, the touch panel is peeled away from the display surface of the display device and again stuck to the display surface of the same or different display device, the double-sided pressure-sensitive adhesive sheet of the invention can be peeled away without causing cracks in the touch panel, etc. Moreover, even when after this peeling, the double-sided pressure-sensitive adhesive sheet of the invention is stuck one more, mingling of bubbles caused by rough pressure-sensitive adhesive coat of the surface of the pressure-sensitive adhesive layer in the display device side can be prevented. Accordingly, the double-sided pressure-sensitive adhesive sheet of the invention is excellent in resticking properties and extremely good in reworkability. Also, since even when a mistake of sticking occurs, the double-sided pressure-sensitive adhesive sheet of the invention can be restuck, it is not required to scrap the touch panel or display device, and hence, it is excellent in manufacturing costs. Additionally, the double-sided pressure-sensitive adhesive sheet of the invention can be recycled so that it is excellent from the standpoints of resource and environment.

Moreover, since the double-sided pressure-sensitive adhesive sheet of the invention does not have a substrate, the thickness can be made thin. Even when it is used in sticking the touch panel to the display device, it is possible to design the touch panel-provided display device so as to have a thin thickness.

Accordingly, when the double-sided pressure-sensitive adhesive sheet of the invention is used, it is possible to effectively design mobile communication terminals mounted with a touch panel as an input unit (such as mobile type telephone terminals such cellular telephones and PHS and PDA terminals) so as to realize low power consumption, high luminance and thin size.

The double-sided pressure-sensitive adhesive sheet of the invention is used in sticking and fixing a touch panel to a display surface of a display device; it can make reworkability in resticking good; it has excellent optical properties; and it can be made thin in thickness. Further, it can enhance durability.

The invention will be more specifically described with reference to the Examples. Incidentally, in the following Examples, all parts and percents are on a weight basis.

### PREPARATION EXAMPLE 1

In a three-necked flask, 92 parts of butyl acrylate as a monomer component of acrylic polymer, 8 parts of acrylic acid, and 100 parts of ethyl acetate as a polymerization solvent were charged, and the mixture was stirred for 2 hours while introducing a nitrogen gas thereinto. After eliminating oxygen within the polymerization system in this way, 0.2 part of 2,2′-azobisisobutyronitrile was added, the temperature was raised to 60° C., and the mixture was reacted for 10 hours. Ethyl acetate was added to the reaction mixture to obtain an acrylic polymer solution having a solids content of 30% (hereinafter referred to as “acrylic polymer A solution”).

### PREPARATION EXAMPLE 2

An acrylic polymer solution having a solids content of 30% (hereinafter referred to as “acrylic polymer B solution”) was prepared in the same manner as in Preparation Example 1, except for using 98 parts of butyl acrylate as the monomer component of acrylic polymer and 2 parts of acrylic acid.

### PREPARATION EXAMPLE 3

An acrylic polymer solution having a solids content of 30% (hereinafter referred to as “acrylic polymer C solution”) was prepared in the same manner as in Preparation Example 1, except for using 98 parts of 2-ethylhexyl acrylate as the monomer component of acrylic polymer and 2 parts of acrylic acid.

### PREPARATION EXAMPLE 4

An acrylic polymer solution having a solids content of 30% (hereinafter referred to as “acrylic polymer D solution”) was prepared in the same manner as in Preparation Example 1, except for using 90 parts of 2-ethylhexyl acrylate as the monomer component of acrylic polymer and 10 parts of acrylic acid.

### PREPARATION EXAMPLE 5

In a three-necked flask, 80 parts of 2-ethylhexyl acrylate as a monomer component of acrylic polymer, 20 parts of acrylic acid, and 150 parts of ethyl acetate as a polymerization solvent were charged, and the mixture was stirred for 2 hours while introducing a nitrogen gas thereinto. After eliminating oxygen within the polymerization system in this way, 0.2 part of 2,2′-azobisisobutyronitrile was added, the temperature was raised to 60° C., and the mixture was reacted for 3 hours. The temperature was further raised to 70° C., and the mixture was reacted for an additional 2 hours. Ethyl acetate was added to the reaction mixture to obtain an acrylic polymer solution having a solids content of 30% (hereinafter referred to as “acrylic polymer E solution”).

### EXAMPLE 1

To the acrylic polymer B solution, glycerin diglycidyl ether was added in a proportion of 2 parts based on 100 parts of the acrylic polymer B in the acrylic polymer B solution, to prepare a pressure-sensitive adhesive solution for pressure-sensitive adhesive layer in the display device side (hereinafter referred to as “pressure-sensitive adhesive A1”). Also, to the acrylic polymer A solution, glycerin diglycidyl ether was added in a proportion of 0.05 part based on 100 parts of the acrylic polymer A in the acrylic polymer A solution, to prepare a pressure-sensitive adhesive solution for pressure-sensitive adhesive layer in the touch panel side (hereinafter referred to as “pressure-sensitive adhesive A2”).

The pressure-sensitive adhesive A1 was cast coated in a thickness after drying of 20 μm on the release treated surface of a release liner made of a release treated polyethylene terephthalate (PET) film (thickness: 38 μm) and heat dried at 100° C. for 3 minutes to form a pressure-sensitive adhesive layer in the display device side. Further, a release liner was stuck onto the pressure-sensitive adhesive layer in the display device side to prepare a PET film having a pressure-sensitive adhesive layer in the display device side (hereinafter referred to as “film A1 having a pressure-sensitive adhesive layer in the display device side”).

Also, the pressure-sensitive adhesive A2 was cast coated in a thickness after drying of 20 μm on the release treated surface of a release liner made of a release treated PET film (thickness: 75 μm) and heat dried at 100° C. for 3 minutes to form a pressure-sensitive adhesive layer in the touch panel side. Further, a release liner was stuck onto the pressure-sensitive adhesive layer in the touch panel side to prepare a PET film having a pressure-sensitive adhesive layer in the touch panel side (hereinafter referred to as “film A2 having a pressure-sensitive adhesive layer in the touch panel side”).

Thereafter, the finally stuck release liners of the film A1 having a pressure-sensitive adhesive layer in the display device side and the film A2 having a pressure-sensitive adhesive layer in the touch panel side were peeled away, respectively. Thereafter, the film A2 having a pressure-sensitive adhesive layer in the touch panel side was stuck to the film A1 having a pressure-sensitive adhesive layer in the display device side such that the pressure-sensitive adhesive layer in the touch panel side of the film A2 having a pressure-sensitive adhesive layer in the touch panel side came into contact with the pressure-sensitive adhesive layer in the display device side of the film A1 having a pressure-sensitive adhesive layer in the display device side, followed by aging at 50° C. for 72 hours. There was thus prepared a double-sided pressure-sensitive adhesive sheet having a crosslinking structured pressure-sensitive adhesive layer.

### EXAMPLE 2

To the acrylic polymer C solution, glycerin diglycidyl ether was added in a proportion of 1 part based on 100 parts of the acrylic polymer C in the acrylic polymer C solution, to prepare a pressure-sensitive adhesive solution for pressure-sensitive adhesive layer in the display device side (hereinafter referred to as “pressure-sensitive adhesive B1”). Also, to the acrylic polymer D solution, glycerin diglycidyl ether was added in a proportion of 0.05 part based on 100 parts of the acrylic polymer D in the acrylic polymer D solution, to prepare a pressure-sensitive adhesive solution for pressure-sensitive adhesive layer in the touch panel side (hereinafter referred to as “pressure-sensitive adhesive B2”). Also, to the acrylic polymer E solution, glycerin diglycidyl ether was added in a proportion of 0.02 part based on 100 parts of the acrylic polymer E in the acrylic polymer E solution, to prepare a pressure-sensitive adhesive solution for intermediate pressure-sensitive adhesive layer (hereinafter referred to as “pressure-sensitive adhesive B3”).

The pressure-sensitive adhesive B3 was cast coated in a thickness after drying of 10 μm on the release treated surface of a release liner made of a release treated PET film (thickness: 38 μm) and heat dried at 100° C. for 3 minutes to form an intermediate pressure-sensitive adhesive layer. Further, the pressure-sensitive adhesive B1 was cast coated in a thickness after drying of 20 μm on the intermediate pressure-sensitive adhesive layer and heat dried at 100° C. for 3 minutes to form a pressure-sensitive adhesive layer in the display device side. Moreover, a release liner was stuck onto the pressure-sensitive adhesive layer in the display device side to prepare a PET film having a pressure-sensitive adhesive layer in the display device side (hereinafter referred to as “film B1 having a pressure-sensitive adhesive layer in the display device side”).

Also, the pressure-sensitive adhesive B2 was cast coated in a thickness after drying of 20 μm on the release treated surface of a release liner made of a release treated PET film (thickness: 75 μm) and heat dried at 100° C. for 3 minutes to form a pressure-sensitive adhesive layer in the touch panel side. Further, a release liner was stuck onto the pressure-sensitive adhesive layer in the touch panel side to prepare a PET film having a pressure-sensitive adhesive layer in the touch panel side (hereinafter referred to as “film B2 having a pressure-sensitive adhesive layer in the touch panel side”).

Thereafter, the release liner in contact with the intermediate pressure-sensitive adhesive layer of the film B1 having a pressure-sensitive adhesive layer in the display device side was peeled away, and the finally stuck release liner of the film B2 having a pressure-sensitive adhesive layer in the touch panel side was also peeled away. Thereafter, the film B2 having a pressure-sensitive adhesive layer in the touch panel side was stuck to the film B1 having a pressure-sensitive adhesive layer in the display device side such that the pressure-sensitive adhesive layer in the touch panel side of the film B2 having a pressure-sensitive adhesive layer in the touch panel side came into contact with the intermediate pressure-sensitive adhesive layer of the film B1 having a pressure-sensitive adhesive layer in the display device side, followed by aging at 50° C. for 72 hours. There was thus prepared a double-sided pressure-sensitive adhesive sheet having a crosslinking structured pressure-sensitive adhesive layer.

### Comparative Example 1

A pressure-sensitive adhesive A1 and a pressure-sensitive adhesive A2 were prepared in the same manner as in Example 1.

The pressure-sensitive adhesive A1 was cast coated in a thickness after drying of 20 μm on one surface of a biaxially stretched PET film (thickness: 12 μm) and heat dried at 100° C. for 3 minutes to form a pressure-sensitive adhesive layer in the display device side. Further, a release liner was stuck onto the pressure-sensitive adhesive layer in the display device side. Thereafter, the pressure-sensitive adhesive A2 was cast coated in a thickness after drying of 20 μm on the other surface of the biaxially stretched PET film and heat dried at 100° C. for 3 minutes to form a pressure-sensitive adhesive layer in the touch panel side. Further, a release liner was stuck onto the pressure-sensitive adhesive layer in the touch panel side, followed by aging at 50° C. for 72 hours. There was thus prepared a double-sided pressure-sensitive adhesive sheet having a crosslinking structured pressure-sensitive adhesive layer.

### Comparative Example 2

A pressure-sensitive adhesive A1 and a pressure-sensitive adhesive A2 were prepared in the same manner as in Example 1. Further, a film A1 having a pressure-sensitive adhesive layer in the display device side and a film A2 having a pressure-sensitive adhesive layer in the touch panel side were prepared in the same manner as in Example 1.

The finally stuck release liners of the film A1 having a pressure-sensitive adhesive layer in the display device side and the film A2 having a pressure-sensitive adhesive layer in the touch panel side were peeled away, respectively. Thereafter, the film A1 having a pressure-sensitive adhesive layer in the display device side was stuck onto one surface of a triacetyl cellulose (TAC) film (thickness: 80 μm) such that the pressure-sensitive adhesive layer in the display device side came into contact with the TAC film. Further, the film A2 having a pressure-sensitive adhesive layer in the touch panel side was stuck onto the other surface of the TAC film such that the pressure-sensitive adhesive layer in the touch panel side came into contact with the TAC film, followed by aging at 50° C. for 72 hours. There was thus prepared a double-sided pressure-sensitive adhesive sheet having a crosslinking structured pressure-sensitive adhesive layer.

### Comparative Example 3

To the acrylic polymer A solution, glycerin diglycidyl ether was added in a proportion of 0.05 part based on 100 parts of the acrylic polymer A in the acrylic polymer A solution, to prepare a pressure-sensitive adhesive solution for pressure-sensitive adhesive layer in the display device side (hereinafter referred to as “pressure-sensitive adhesive C1”). Also, to the acrylic polymer A solution, glycerin diglycidyl ether was added in a proportion of 0.05 part based on 100 parts of the acrylic polymer A in the acrylic polymer A solution, to prepare a pressure-sensitive adhesive solution for pressure-sensitive adhesive layer in the touch panel side (hereinafter referred to as “pressure-sensitive adhesive C2”).

A double-sided pressure-sensitive adhesive sheet consisting of only two layers of a transparent pressure-sensitive adhesive layer in the display device side and a transparent pressure-sensitive adhesive layer in the touch panel side was prepared in the same manner as in Example 1, except for using the pressure-sensitive adhesive C1 in place of the pressure-sensitive adhesive A1 and using the pressure-sensitive adhesive C2 in place of the pressure-sensitive adhesive A2.

(Evaluation)

The double-sided pressure-sensitive adhesive sheets of Examples 1 to 2 and Comparative Examples 1 to 3 were evaluated with respect to the adhesion, reworkability and optical characteristic in the following methods. The evaluation results are shown in Table 1.

Also, the thickness of each of the double-sided pressure-sensitive adhesive sheets was measured. As a result, the case where the thickness is not more than 50 μm is designated as “◯” (good because of thin thickness); the case where the thickness exceeds 50 μm and is not more than 100 μm is designated as “Δ” (moderate because of slightly thick thickness); and the case where the thickness exceeds 100 μm is designated as “X” (not allowable because of thick thickness). The evaluation results are also shown in Table 1.

(Evaluation Method of Adhesion)

A polyethylene terephthalate film (a trade name: “LUMIRROR S-10#25”, manufactured by Toray Industries, Inc.) was stuck onto a different surface of the double-sided pressure-sensitive adhesive sheet from the surface for measurement of the adhesive strength and then cut into a width of 20 mm. Each adherend [a glass plate or “ARTON” (a trade name of norbornene based resin film, manufactured by JSR Corporation)] was stuck onto the surface of measurement of the adhesive strength by reciprocating a roller once in an atmosphere at 23° C. under a load of 19.6 N and then treated in an autoclave at 50° C. and at 5 atmospheres for 15 minutes. The test sample was taken out from the autoclave, allowed to stand under the condition at 23° C. for 120 minutes, and then measured for the 180°-peeling adhesive strength at a peeling rate of 300 mm/min using a tensilon type peel tester.

Incidentally, in the case where the surface for measurement of the adhesive strength is the pressure-sensitive adhesive layer in the display device side, the adherend is a glass plate (thickness: 1.0 μm), and in the case where the surface for measurement of the adhesive strength is the pressure-sensitive adhesive layer in the touch panel side, the adherend is “ARTON” (a trade name) (thickness: 70 μm).

(Evaluation Method of Reworkability)

A PET film (thickness of PET film: 100 μm) on one surface of which a transparent thin film made of ITO (indium-tin oxide) was stuck to a glass plate via the double-sided pressure-sensitive adhesive sheet and treated in an autoclave at 50° C. and at 5 atmospheres for 15 minutes. The resulting test sample was peeled away at a rate of 300 mm/min and at a peeling angle of about 30° to 60°. At that time, peeling-resistant feeling and the presence or absence of bubble biting caused by rough pressure-sensitive adhesive coat of the surface of the pressure-sensitive adhesive layer and the presence or absence of cracks in the ITO-provided PET film when sticking once again were visually confirmed. The reworkability was evaluated according to the following criteria.

◯: The test sample is good.

X: The test sample is inconvenient such that the peeling resistance is heavy, bubble biting occurs, or cracks are formed.

Incidentally, in the evaluation method of resticking properties, the ITO-provided PET film is corresponding to an electrode in the lower side of the touch panel having an F/F type construction, and the glass plate is corresponding to the display surface of the display device.

(Evaluation Method of Optical Characteristics)

A polarizing plate (a trade name: “SEG1425DU”, manufactured by Nitto Denko Corporation) was stuck on the both surfaces of the double-sided pressure-sensitive adhesive sheet. in the cross nicol state and measured for total luminous transmittance. The optical characteristics were evaluated according to the following criteria.

◯: The total luminous transmittance is less than 5%.

X: The total luminous transmittance is 5% or more.

TABLE 1

| | Example | | Comparative Example | | |
|---|---|---|---|---|---|
| | 1 | 2 | 1 | 2 | 3 |
| Pressure-sensitive adhesive layer | | | | | |
| in the display device side | | | | | |
| Kind of acrylic polymer | Acrylic | Acrylic | Acrylic | Acrylic | Acrylic |
| | polymer B | polymer C | polymer B | polymer B | polymer A |
| Proportion of crosslinking | 2 | 1 | 2 | 2 | 0.05 |
| agent to acrylic polymer | | | | | |
| Pressure-sensitive adhesive layer | | | | | |
| in the touch panel side | | | | | |
| Kind of acrylic polymer | Acrylic | Acrylic | Acrylic | Acrylic | Acrylic |
| | polymer A | polymer D | polymer A | polymer A | polymer A |
| Proportion of crosslinking | 0.05 | 0.05 | 0.05 | 0.05 | 0.05 |
| agent to acrylic polymer | | | | | |
| Between the foregoing layers | | | | | |
| Material (thickness: μm) | — | Acrylic | PET | TAC | — |
| | | polymer E | (12 μm) | (80 μm) | |
| | | (10 μm) | | | |
| Adhesion | | | | | |
| Pressure-sensitive adhesive | 1.9 | 1.5 | 1.9 | 1.9 | 7.2 |
| layer in the display device | | | | | |
| side (to glass plate) | | | | | |
| Pressure-sensitive adhesive | 6.7 | 5.8 | 8.2 | 8.9 | 6.7 |
| layer in the touch panel side | | | | | |
| (to ARTON) | | | | | |
| Reworkability | ◯ | ◯ | ◯ | ◯ | X |
| | | | | | (Cracks) |
| Optical characteristics | ◯ | ◯ | X | ◯ | ◯ |
| Thickness | ◯ | ◯ | Δ | X | ◯ |
| | 40 μm | 50 μm | 52 μm | 120 μm | 40 μm |

It is noted from Table 1 that the double-sided pressure-sensitive adhesive sheets according to Examples 1 and 2 have a thin thickness as not more than 50 μm and have excellent optical characteristics. Also, since the adhesive strength of the pressure-sensitive adhesive layer in the display device side is lower than the adhesive strength of the pressure-sensitive adhesive layer in the touch panel side and is proper, each the double-sided pressure-sensitive adhesive sheets can be easily peeled ways from the display surface of the display device together with the touch panel, can be again stuck on the display surface of the display without mingling of bubbles, and is extremely excellent in reworkability. As a matter of course, since all the pressure-sensitive adhesive layers are formed of an acrylic pressure-sensitive adhesive, the double-sided pressure-sensitive adhesive sheets according to Examples 1 and 2 have good durability.

On the other hand, Comparative Example 1 is not satisfactory with respect to the optical characteristics and thickness, and Comparative Example 2 is not satisfactory with respect to the thickness. Incidentally, in Comparative Example 3, since both the adhesive strengths to the pressure-sensitive adhesive layer in the display device side and to the pressure-sensitive adhesive layer in touch panel side are so large that the double-sided pressure-sensitive adhesive sheet does not have a repeatedly peelable construction, it is low in reworkability and forms cracks during peeling.

While the invention has been described in detail and with reference to specific embodiments thereof, it will be apparent to one skilled in the art that various changes and modifications can be made therein without departing from the spirit and scope thereof.

What is claimed is:

1. A double-sided pressure-sensitive adhesive sheet to be used in sticking and fixing a touch panel to a display surface of a display device, one surface of the double-sided pressure-sensitive adhesive sheet being stuck substantially entirely on the touch panel, and the other surface being stuck substantially entirely on the display surface of the display device, wherein the double-sided pressure-sensitive adhesive sheet has at least two pressure-sensitive adhesive layers but does not have a substrate, is constructed such that it is repeatedly peelable against at least one surface of the touch panel and the display surface of the display device, and has optical isotropy.

2. The double-sided pressure-sensitive adhesive sheet according to claim 1, which has from two to five pressure-sensitive adhesive layers.

3. The double-sided pressure-sensitive adhesive sheet according to claim 1, wherein the pressure-sensitive adhesive layers at least in the both outer sides are formed of an acrylic pressure-sensitive adhesive.

4. The double-sided pressure-sensitive adhesive sheet according to claim 1, wherein at least one pressure-sensitive adhesive layer of the pressure-sensitive adhesive layers in the both outer sides has a 180°-peeling adhesive strength (to a glass plate or a triacetyl cellulose film at a peeling rate of 300 mm/min at 23° C.) of not more than 5.0 N/20 mm.

5. The double-sided pressure-sensitive adhesive sheet according to claim 1, which is used for fixing a display device to a touch panel in the inner touch panel system.

6. A touch panel-provided display device, wherein a display device and a touch panel are fixed to each other via the double-sided pressure-sensitive adhesive sheet according to any one of claims 1 to 5.
